(19) United States
(12) Patent Application Publication
(10) Pub. No.: US 2009/0172954 A1
(43) Pub. Date: Jul. 9, 2009

(54) Coded Aviation Snips

(76) Inventors: Joseph Thomas Novak, East Longmeadow, MA (US); Peter Weremchuk, South Windsor, CT (US)

Correspondence Address: MCCARTER & ENGLISH, LLP HARTFORD;CITYPLACE I, 185 ASYLUM STREET, HARTFORD, CT, 06103, US

(21) Appl. No.: 11/969,858

(22) Filed: Jan. 4, 2008

(51) Int. Cl. B26B 13/00

(52) U.S. Cl. 30/244

(57) ABSTRACT

A plurality of aviation snips, each snip comprising a visible graphic indicia indicative of the respective type of snip and visibly different from the graphic indicia of every other type of snip. The indicia is placed on the end portion of the upper handle grip to indicate the orientation of the snip relative to the user's hand during use, and is optionally debossed to add a tactile feel element to the indicia such that the user can determine the type of snip by feeling the indicia without visual contact. Each snip is optionally color coded on the spine of the snip to indicate the cutting direction of the snip.

### FIELD OF THE INVENTION

The present invention relates to aviation snips and, more particularly, a set of aviation snips coded to indicate the type and/or cutting direction of each snip.

### BACKGROUND

Aviation snips are hand tools used to cut sheet metal, linoleum, carpet, tile and other materials. The snips typically employ a compound lever mechanism that reduces the amount of effort required to cut the material in comparison to single lever snips commonly known as tin snips. The most common types of aviation snips are the straight cutting aviation snip, the left cutting aviation snip and the right cutting aviation snip. Additionally, there is a straight short cutting or “bulldog” aviation snip, as well as an offset left cutting aviation snip and an offset right cutting aviation snip. The offset snips maintain the user's hands above the work piece during use.

To assist the end user in determining the cutting direction of a particular snip, manufacturers color the handles according to an industry standard color coding system, where yellow indicates a straight cut, red indicates a left cut and green indicates a right cut. Although this system is useful, it does come with a few drawbacks. One drawback is that the color coding is only applied to the handle of the snip, which prevents users from determining the cutting direction of a particular snip if the handle is covered or otherwise not in the user's line of sight. This occurs most often, for example, when the snips are placed in a tool bag or tool box filled with a variety of tools that cover over each other, or in scenarios where the snips are placed in the sheaths or pockets of a tool belt with the handles facing downward (i.e. the snips are placed in the tool belt handles first) so that the sheaths or pockets cover the handles.

Another drawback to the color coding system recited above is that the system typically is the sole system used to assist users in identifying the cutting direction of aviation snips. Therefore, users with color blindness or other visual impairments that make it impossible or difficult to recognize the colors applied to snip handles will not be able to rely on this color coding system to identify the cutting direction of the snips.

Another drawback to the color coding system recited above is that the system provides no indication representative of the specific types of aviation snips (i.e. straight aviation, bulldog aviation, left aviation, right aviation, offset left aviation, offset right aviation, etc.); that is, the system is only capable of indicating cutting direction. Because both straight cutting aviation snips and bulldog (short straight cutting) aviation snips have yellow handles, both left cutting aviation snips and offset left cutting aviation snips have red handles, and both right cutting aviation snips and offset right cutting aviation snips have green handles, users looking into a tool bag, tool box or at their tool belt (especially tool belts where the snip handles are facing upward, i.e. the snips are placed in the tool belt cutting jaw first), will not be able to identify the particular type of snip by color alone. For example, if a user sees a red handled snip in his or her toolbag, he or she will not be able to determine whether the snip is a left cutting snip or an offset left cutting snip, etc.

Accordingly, it is an object of the present invention to overcome one or more of the above-described drawbacks and/or disadvantages of the prior art.

### SUMMARY OF THE INVENTION

In accordance with a first aspect, the invention is directed to a plurality of aviation snips, each snip of a different type and including a spine, a handle connected to the spine and a cutting jaw mechanically coupled to the spine. The handle includes an upper grip and a lower grip. Each snip comprises a visible graphic indicia indicative of the respective type of snip and visibly different from the graphic indicia of every other type of snip.

In the currently preferred embodiments of the invention, the visible graphic indicia includes (i) a first substantially vertical visible graphic indicia defining a first length and applied to a straight cutting aviation snip; (ii) a second substantially vertical visible graphic indicia defining a second length shorter than the first length and applied to a short straight cutting or bulldog aviation snip; (iii) a visible graphic indicia including at least a portion thereof that is tilted and/or curved to the left of vertical and applied to a left cutting aviation snip; (iv) a visible graphic indicia including at least a portion thereof tilted and/or curved to the right of vertical and applied to a right cutting aviation snip; (iv) a substantially horizontal visible graphic indicia pointed to the left and applied to an offset left cutting aviation snip; and (v) a substantially horizontal visible graphic indicia pointed to the right and applied to a right offset cutting aviation snip.

In some embodiments of the invention, the visible graphic indicia is an arrow. Preferably, the arrow defines the following variations: a first substantially vertical arrow having a first length, a second substantially vertical arrow having a second length shorter than the first length, a first curved arrow defining a curvature to the left, a second curved arrow defining a curvature to the right, a first substantially horizontal arrow pointing to the left, and a second substantially horizontal arrow pointing to the right. The first vertical arrow represents a straight cutting aviation snip, the second vertical arrow represents a short straight cutting or bulldog aviation snip, the first curved arrow represents a left cutting aviation snip, the second curved arrow represents a right cutting aviation snip, the first horizontal arrow represents an offset left cutting aviation snip, and the second horizontal arrow represents a right offset cutting aviation snip. In some embodiments of the invention, the visible graphic indicia is located about an end portion of the top grip indicating correct orientation of the particular aviation snip during use.

In some embodiments of the invention, the graphic indicia is provided with a tactile feel element to allow a user to determine the type of snip by touching the graphic indicia. In some such embodiments, the graphic indicia is debossed relative an outer surface of the handle, the graphic indicia is raised relative to the outer surface of the handle, the border of the graphic indicia is debossed relative to the outer surface of the handle, and/or the border of the graphic indicia is raised relative to the outer surface of the handle.

In some embodiments of the invention, the snips further comprise a color coding scheme including a plurality of colors. Each color represents a cutting direction of the respective snip, including a straight cutting direction, a left cutting direction and a right cutting direction. In some such embodiments, yellow represents the straight cutting direction, red indicates a left cutting direction and green indicates a right cutting direction. The color coding scheme is located on at least one of: (i) the spine, (iii) the cutting jaw, (iv) on or about the visible graphic indicia, and (iv) any combination thereof.

In accordance with another aspect, the invention is directed to a plurality of aviation snips, each snip of a different type and including a spine, a handle connected to the spine and a cutting jaw mechanically coupled to the spine. The handle includes an upper grip and a lower grip. Each snip comprises means for providing a visual representation of the respective snip and visibly different from said means on every other type of snip of the plurality of snips.

In some embodiments of the invention, the means for providing a visual representation of the respective snip is a visible graphic indicia. In some such embodiments, the graphic indicia is an arrow defining a plurality of variations including: a first substantially vertical arrow having a first length, a second substantially vertical arrow having a second length shorter than the first length, a first curved arrow defining a curvature to the left, a second curved arrow defining a curvature to the right, a first substantially horizontal arrow pointing to the left, and a second substantially horizontal arrow pointing to the right. The first vertical arrow represents a straight cutting aviation snip, the second vertical arrow represents a short straight cutting or bulldog aviation snip, the first curved arrow represents a left cutting aviation snip, the second curved arrow represents a right cutting aviation snip, the first horizontal arrow represents an offset left cutting aviation snip, and the second horizontal arrow represents a right offset cutting aviation snip.

In some embodiments of the invention the means for providing a visual representation of the respective snip includes means for providing a tactile feel to the graphic indicia to allow a user to determine the type of snip by feeling the graphic indicia. In some such embodiments, the means for providing a tactile feel is defined by the graphic indicia being debossed relative an outer surface of the handle, the graphic indicia being raised relative to the outer surface of the handle, the border of the graphic indicia being debossed relative to the outer surface of the handle, and/or the border of the graphic indicia being raised relative to the outer surface of the handle.

In another aspect of the invention, the snips further comprise means for visually indicating a cutting direction of the snip. In one embodiment, said means is a color coding scheme including a plurality of colors, each color representing the cutting direction of the snip including a straight cutting direction, a left cutting direction and a right cutting direction. In a currently preferred embodiment, yellow represents the straight cutting direction, red indicates a left cutting direction and green indicates a right cutting direction. In some embodiments of the invention, the means for visually indicating a cutting direction of the snip is located on at least one of: (i) the spine, (ii) the cutting jaw, (iii) the handle, (iv) on about the visible graphic indicia, and (iv) any combination thereof.

One advantage of the coded aviation snips of the invention is that the visible graphic indicia identifies the respective type of snip, and not just the cutting direction of the snip as with the color coding scheme of the prior art. Yet another advantage of the coded aviation snips of the invention is that it need not be color dependent, and therefore is effective for users with color blindness or other visual irregularities that prevent reliance on the color coding scheme of the prior art. Another advantage of some currently preferred embodiments of the invention is that the user can both visually and non-visually (i.e. by feel) determine the cutting direction (i.e. straight, left, right) of a particular type of snip. Additionally, in some such embodiments, the user can both visually and non-visually (i.e. by feel) determine the exact type of snip of a set of aviation snips (i.e. straight cutting, bulldog, left cutting, right cutting, offset left cutting, and offset right cutting). Furthermore, in some such embodiments, the user can both visually and non-visually (i.e. by feel) determine the correct orientation of the snip during use.

Other objects, advantages and features of the coded aviation snips of the present invention will become more readily apparent in view of the following detailed description of the currently preferred embodiments and accompanying drawings.

### BRIEF DESCRIPTION OF THE DRAWINGS

FIG. 1 is a side perspective view of a straight cutting aviation snip according to an embodiment of the invention.

FIG. 2 is a side perspective view of a straight short cutting or “bulldog” aviation snip according to an embodiment of the invention.

FIG. 3 is a side perspective view of a left cutting aviation snip according to an embodiment of the invention.

FIG. 4 is a side perspective view of a right cutting aviation snip according to an embodiment of the invention.

FIG. 5 is a side perspective view of an offset left cutting aviation snip according to an embodiment of the invention.

FIG. 6 is a side perspective view of an offset right cutting aviation snip according to an embodiment of the invention.

FIG. 7 is a table showing the variations of the visible graphic indicia according to an embodiment of the present invention.

FIG. 8 is a table showing the color scheme according to an embodiment of the present invention.

### DETAILED DESCRIPTION OF THE CURRENTLY PREFERRED EMBODIMENTS

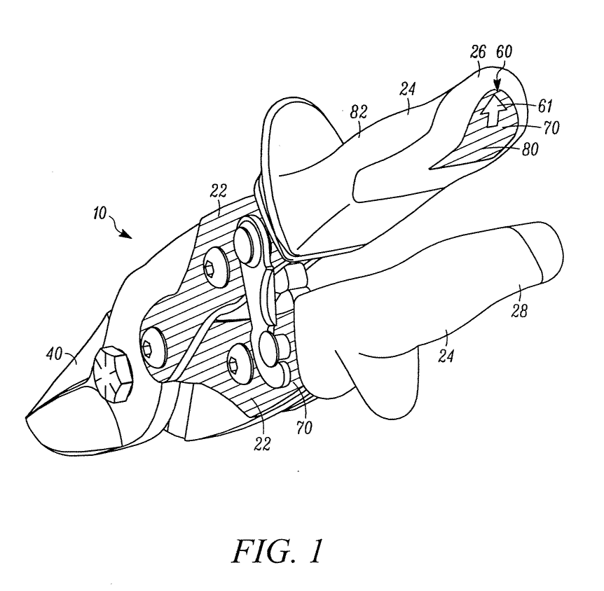

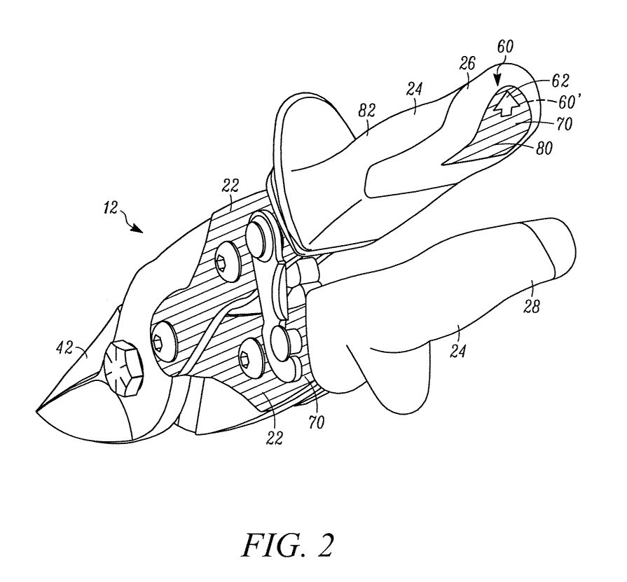

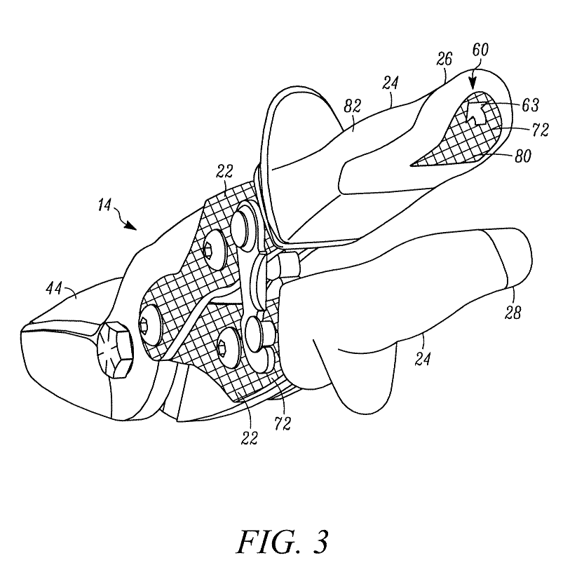

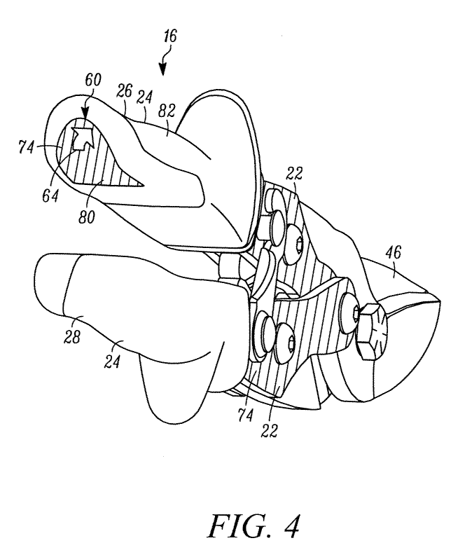

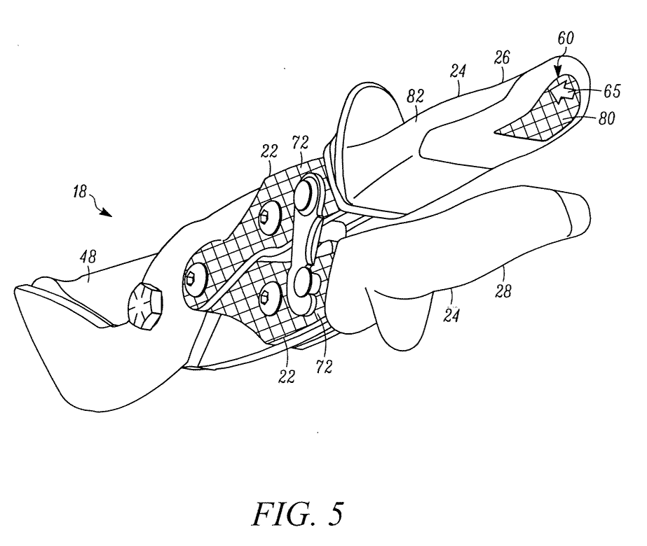

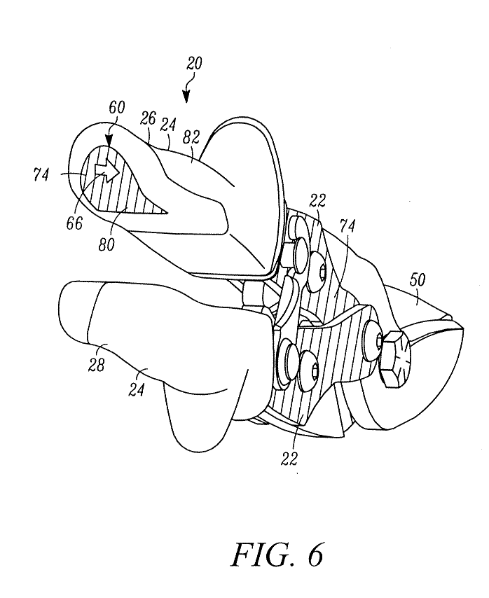

The invention is directed to a plurality of aviation snips comprising a visual representation indicative of the respective type of snip and visibly different from the visual representation of every other type of snip. In the illustrated embodiments, the plurality of snips includes at least: a straight cutting aviation snip 10 (FIG. 1), a short straight cutting or “bulldog” aviation snip 12 (FIG. 2), a left cutting aviation snip 14 (FIG. 3), a right cutting aviation snip 16 (FIG. 4), an offset left cutting aviation snip 18 (FIG. 5) and an offset right cutting aviation snip 20 (FIG. 6). It should be known, however, that the system is easily expandable to include additional aviation snips and other hand tools.

Referring to FIGS. 1-6, a typical embodiment of each of the above-mentioned aviation snips is shown. Each snip 10, 12, 14, 16, 18, 20 includes a spine 22 and a handle 24 overlying a portion of the spine 22. The handle 24 comprises an upper grip 26 and a lower grip 28, each grip 26, 28 defining an end portion 30, 32 respectively. Unique to each snip 10, 12, 14, 16, 18, 20 is a respective cutting jaw 40, 42, 44, 46, 48, 50, which is mechanically coupled to the spine 22. Each cutting jaw is designed to cut through a desired work piece in either a straight cutting direction, a left cutting direction or a right cutting direction (discussed in further detail below).

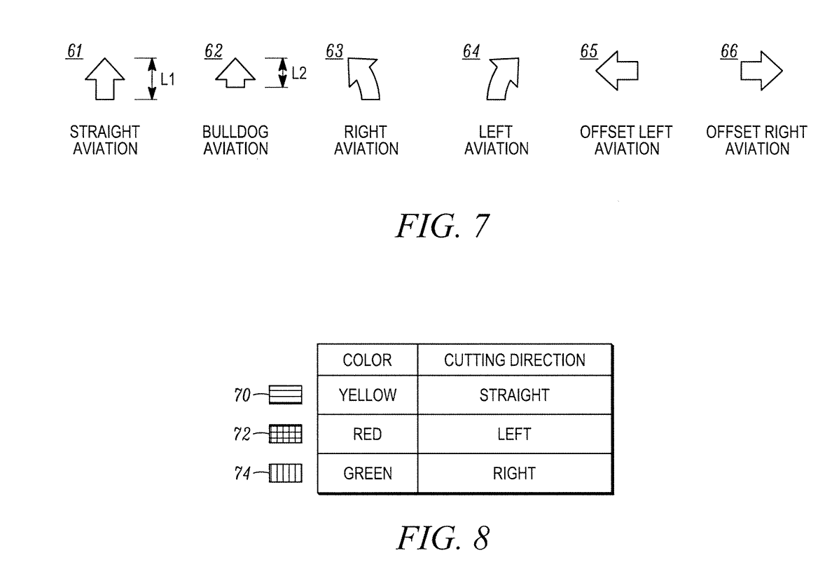

Referring now to FIG. 7, a chart illustrating an embodiment of the visible representation of the snips 10, 12, 14, 16, 18, 20 is shown, wherein the representation is a visible graphic indicia 60 defining a plurality of variations 61, 62, 63, 64, 65, 66, each variation corresponding to the particular type of snip. It should be noted, however, that it is not a requirement that every snip in the plurality of snips include a visible graphic indicia, as a lack of visual indicia can represent a particular snip where the other snips include graphic indicia. In the illustrated embodiments, the visible graphic indicia 60 is represented by an arrow; however it should be noted that the graphic indicia 60 can take on numerous configurations that are currently known or that later become known. For example, the graphic indicia 60 could be a letter, a number, a graphic corresponding to the shape of each cutting jaw, a combination of letters and arrows, a combination of numbers and arrows, or any combination thereof. In the illustrated embodiment, the visible graphic indicia 60 on the plurality of snips has a common theme, i.e. an arrow; however, it should be noted that it is not a requirement that a common theme be used for the visible graphic indicia 60 throughout the entire plurality of snips and, therefore, graphic indicia with differing themes can be used on one or more snips to assist the user in identifying the particular type of snip.

The visible graphic indicia 60 can be placed on any portion of the snip 10, 12, 14, 16, 18, 20. In one embodiment, the indicia 60 is located on the handle 24 of the snip, while in the illustrated embodiment, the indicia 60 is located on the respective end portion 30, 32 of one of the grips 26, 28 to indicate the proper orientation of the snips relative to the user's hand during use. Whether the indicia 60 is located on the end portion 30 of the upper grip 26 or the end portion 32 of the lower grip may not be important, so long as the indicia 60 is orientated to indicate the correct cutting direction of each snip.

Referring to FIG. 7, the variations 61, 62, 63, 64, 65, 66 of the visual indicia 60 according to an embodiment of the invention are shown. In the illustrated embodiment, the variations are selected from the group consisting of: a first straight vertical arrow 61 having a first length L1, a second straight vertical arrow 62 having a second length L2 shorter than the first length, a first curved arrow 63 defining a curvature to the left, a second curved arrow 64 defining a curvature to the right, a first straight horizontal arrow 65 pointing to the left, and a second straight horizontal arrow 66 pointing to the right. With respect to identifying each type of aviation snip, the first straight vertical arrow 61 represents the straight cutting aviation snip 10, the second straight vertical arrow 62 represents the short straight cutting or bulldog aviation snip 12, the first curved arrow 63 represents a left cutting aviation snip 14, the second curved arrow 64 represents a right cutting aviation snip 16, the first horizontal arrow 65 represents an offset left cutting aviation snip 18 and the second horizontal arrow 66 represents a right offset cutting aviation snip 20. It should be noted that the illustrated embodiment of the graphic indicia 60 is not limited to the above-mentioned variations shown in FIG. 7 and can take on numerous additional variations, modifications and alterations that are currently known or later become known.

To further assist the user in identifying a particular snip, the visible graphic indicia 60 can incorporate a tactile feel element. A graphic indicia incorporating a tactile feel element is indicated generally in broken lines as 60′ in FIG. 2. The tactile element enables the user to determine the type of snip by touching or feeling the graphic indicia 60′ without making visual contact, which is particularly useful when the snips are placed in a tool belt with the handles facing upwards (i.e. the snips are placed in the tool belt cutting jaw first) allowing the user to select the required snip without looking away from the work piece. In one embodiment, the visible graphic indicia 60′ is debossed or recessed into the handle 24 so as to provide the above-described tactile feel element. In an alternative embodiment, the visible graphic indicia 60′ can be raised relative to the outer surface of the handle 24 to provide the tactile feel element, or the graphic indicia 60′ can be partially raised and partially debossed. Further, it should be noted that at least one snip in the plurality of snips could have a debossed graphic indicia while at least one snip could have a raised graphic indicia and, if desired, at least one snip could have a flush (i.e. neither debossed or raised) graphic indicia, the debossed, raised and flush graphic indicia identifying particular snips. In another alternative embodiment, the border of the graphic indicia 60′, and not the graphic indicia itself, could be debossed or raised as desired to provide the tactile feel element.

Referring now to FIG. 8, an additional element of a preferred embodiment of the coding system is shown. The element is a color coding scheme including a plurality of colors, each color representing one of the cutting directions (straight, left, right) of the aviation snips 10, 12, 14, 16, 18, 20. In the illustrated embodiment, the industry standard colors of yellow 70, red 72 and green 74 are used, where yellow corresponds to the straight cutting direction, red corresponds to the left cutting direction and green corresponds to the right cutting direction. However, it should be noted that any set of colors can be used, each color identifying a particular cutting direction. The color coding scheme can be used (located) on at least one of the spine 22, cutting jaw 40, 42, 44, 46, 48, 50, handle, on or about the visible graphic indicia, sleeve 82 (described in further detail below) and any combination thereof. In the illustrated embodiment, the color coding is located on the spine 22 to enable the user to identify the cutting direction (straight, left, right) of the snip if the handle 24 and/or cutting jaw 40, 42, 44, 46, 48, 50 and/or graphic indicia 60 is obstructed from the user's view; additionally, the color coding is used (located) on or about the graphic indicia 60. It should be noted that as an alternative to having three colors, one color for each cutting direction, the color coding system can employ a plurality of colors, one color for each type of aviation snip.

In one embodiment of the invention, the visible graphic indicia 60 is placed and/or debossed into an insert 80. The insert is then connected to the spine 22 and the respective handle grip 26, 28 is overmolded about the insert 80. Optionally, a sleeve 82 is overmolded about, or otherwise co-molded with at least one of the handle grips 26, 28 to provide an additional visual indication of the proper orientation of the snip relative to the user's hand during use. In the illustrated embodiment, the upper grip 26 is overmolded about the insert 80 and the sleeve 82 is overmolded about the upper grip 26. At least one of the sleeve 82, upper grip and lower grip 28 can define a textured surface (not shown) for improved gripping and control of the snip during use and/or for added comfort. Further, the sleeve 82 can be colorized for improving the visual indication of the proper orientation of the snip during use and/or for brand identification purposes.

The system for coding aviation snips described herein can provide both visual and non-visual (i.e. by feel) identification of both the cutting direction (e.g. straight, left, right) and the type of snip of a set of aviation snips (e.g. straight cutting, bulldog, left cutting, right cutting, offset left cutting, and offset right cutting). Furthermore, the system can provide both visual and non-visual (i.e. by feel) identification of the correct orientation of the snip during use.

As may be recognized by those of ordinary skill in the pertinent art based on the teachings herein, numerous changes and modifications may be made to the above-described and other embodiments of the present invention without departing from the invention as defined in the appended claims. Accordingly, this detailed description of the described embodiments is to be taken in an illustrative, as opposed to a limiting sense.

What is claimed is:

1. A plurality of aviation snips, each snip of a different type and including a spine, a handle connected to the spine, the handle including an upper grip and a lower grip, and a cutting jaw mechanically coupled to the spine, each snip comprising:
a visible graphic indicia indicative of the respective type of snip and visibly different from the graphic indicia of every other type of snip.

2. A plurality of aviation snips as defined in claim 1, further comprising a straight cutting aviation snip bearing a first substantially vertical visible graphic indicia defining a first length, and a short straight cutting or bulldog aviation snip bearing a second substantially vertical visible graphic indicia defining a second length shorter than the first length.

3. A plurality of aviation snips as defined in claim 1, further comprising a left cutting aviation snip bearing a visible graphic indicia including at least a portion thereof that is at least one of tilted and curved to the left of vertical, and a right cutting aviation snip bearing a visible graphic indicia including at least a portion thereof that is at least one of tilted and curved to the right of vertical.

4. A plurality of aviation snips as defined in claim 1, further comprising an offset left cutting aviation snip bearing a substantially horizontal visible graphic indicia pointed to the left, and a right offset cutting aviation snip bearing a substantially horizontal visible graphic indicia pointed to the right.

5. A plurality of aviation snips as defined in claim 1, wherein the visible graphic indicia is represented by an arrow, and the arrow defines at least a plurality of the following variations: a first substantially vertical arrow having a first length and applied to a straight cutting aviation snip; a second substantially vertical arrow having a second length shorter than the first length and applied to a short straight cutting or bulldog aviation snip; a first curved arrow defining a curvature to the left and applied to a left cutting aviation snip; a second curved arrow defining a curvature to the right and applied to a right cutting aviation snip; a first substantially horizontal arrow pointing to the left and applied to an offset left cutting aviation snip; and a second substantially horizontal arrow pointing to the right and applied to a right offset cutting aviation snip.

6. A plurality of aviation snips as defined in claim 1, wherein the visible graphic indicia is located about an end portion of the top grip indicating correct orientation of the snip during use.

7. A plurality of aviation snips as defined in claim 1, wherein, for at least one snip, at least one of (i) the visible graphic indicia is debossed relative an outer surface of the handle, (ii) the visible graphic indicia is raised relative to the outer surface of the handle, (iii) the border of the visible graphic indicia is debossed relative to the outer surface of the handle, and (iv) the border of the visible graphic indicia is raised relative to the outer surface of the handle, thus adding a tactile feel to the visible graphic indicia to allow a user to determine the type of snip by touching the graphic indicia.

8. A plurality of aviation snips as defined in claim 1, further comprising a color coding scheme including at least three colors, a first color indicating a straight cutting direction, a second color indicating a left cutting direction, and a third color indicating a right cutting direction.

9. A plurality of aviation snips as defined in claim 8, wherein the color coding scheme is applied to the spine and on or about the visible graphic indicia of each snip.

10. A plurality of aviation snips as defined in claim 1, wherein the visible graphic indicia is located on an insert and at least one of the upper and lower grips is co-molded with the insert.

11. A plurality of aviation snips as defined in claim 10, further comprising a sleeve co-molded with at least one of the upper and lower grips, the sleeve providing an additional visual indication of the proper orientation of each snip relative to the user's hand during use.

12. A plurality of aviation snips, wherein each snip is of a different type than the others, and comprises:
a spine;
a handle connected to the spine, the handle including an upper grip and a lower grip;
a cutting jaw mechanically coupled to the spine; and
means for providing a visual representation of the respective snip that is visibly different from said means on every other type of snip of the plurality of snips.

13. A plurality of aviation snips as defined in claim 12, wherein the means for providing a visual representation of the respective snip is a visible graphic indicia.

14. A plurality of aviation snips as defined in claim 13, wherein the visible graphic indicia includes (i) a first substantially vertical visible graphic indicia defining a first length and applied to a straight cutting aviation snip; (ii) a second substantially vertical visible graphic indicia defining a second length shorter than the first length and applied to a short straight cutting or bulldog aviation snip; (iii) a visible graphic indicia including at least a portion thereof tilted to the left of vertical and applied to a left cutting aviation snip; (iv) a visible graphic indicia including at least a portion thereof tilted to the right of vertical and applied to a right cutting aviation snip; (iv) a substantially horizontal visible graphic indicia pointed to the left and applied to an offset left cutting aviation snip; and (v) a substantially horizontal visible graphic indicia pointed to the right and applied to a right offset cutting aviation snip.

15. A plurality of aviation snips as defined in claim 13, wherein the indicia is represented by an arrow.

16. A plurality of aviation snips as defined in claim 15, wherein the indicia defines a plurality of variations selected from the group consisting of: a first substantially vertical arrow having a first length, a second substantially vertical arrow having a second length shorter than the first length, a first curved arrow defining a curvature to the left, a second curved arrow defining a curvature to the right, a first substantially horizontal arrow pointing to the left, and a second substantially horizontal arrow pointing to the right.

17. A plurality of aviation snips as defined in claim 13, further comprising means for providing a tactile feel to the visible graphic indicia to allow a user to determine the type of snip by feeling the graphic indicia.

18. A plurality of aviation snips as defined in claim 13, further comprising means for visually indicating a cutting direction of the snip.

19. A plurality of aviation snips as defined in claim 18, wherein the means for visually indicating the cutting direction of the snip is applied to the spine and on or about the visible graphic indicia of each snip.

20. A plurality of aviation snips as defined in claim 12, wherein the means for providing a visual representation of the respective snip is located on an insert co-molded to the handle of the snip.
